(19) United States
(12) Patent Application Publication
(10) Pub. No.: US 2023/0304817 A1
(43) Pub. Date: Sep. 28, 2023

(54) TRANSIT POINT SETTING DEVICE, TRANSIT POINT SETTING METHOD, AND TRANSIT POINT SETTING PROGRAM

(71) Applicant: NIPPON TELEGRAPH AND TELEPHONE CORPORATION, Tokyo (JP)

(72) Inventors: Kenichi FUKUDA, Tokyo (JP); Atsuhiko MAEDA, Tokyo (JP); Kazuaki OBANA, Tokyo (JP); Sun Yeong KIM, Tokyo (JP); Yukio KIKUYA, Tokyo (JP)

(73) Assignee: NIPPON TELEGRAPH AND TELEPHONE CORPORATION, Tokyo (JP)

(21) Appl. No.: 18/020,395

(22) PCT Filed: Aug. 11, 2020
(86) PCT No.: PCT/JP2020/030612

§ 371 Date: Feb. 8, 2023

(51) Int. Cl. G01C 21/34; G06F 18/23; G06F 18/2413

(52) U.S. Cl. CPC G01C 21/3492; G06F 18/23; G06F 18/24137

(57) ABSTRACT

A waypoint setting device sets a waypoint on the basis of a predictive distribution representing a demand prediction of occurrence points indicating positions from which a mobile object is called, position information indicating a position of a target mobile object that is a mobile object for which the waypoint is to be set, and destination information indicating information regarding a destination to which the target mobile object is to be moved. Then, the waypoint setting device outputs the set waypoint.

### TECHNICAL FIELD

The disclosed technology relates to a waypoint setting device, a waypoint setting method, and a waypoint setting program.

### BACKGROUND ART

A technology related to a system for optimal operation of ambulance vehicles using emergency big data has conventionally been known (see, for example, Non Patent Literature 1). Non Patent Literature 1 discloses a technology aimed at shortening the time required for arrival at a scene and the time required for transport to a hospital when an ambulance takes a sick or injured person to the hospital.

### CITATION LIST

### Non Patent Literature

Non Patent Literature 1: National Research Institute of Fire and Disaster, Nippon Telegraph and Telephone Corporation, and NTT DATA Corporation, “System for optimal operation of ambulance vehicles using emergency big data has been confirmed to be effective—for reduction of ambulance transport time by real-time emergency demand prediction and the like”, [online], Nov. 26, 2018, [searched on Jul. 15, 2020], the Internet <URL:https://www.ntt.co.jp/news2018/1811/181126a.html>

### SUMMARY OF INVENTION

### Technical Problem

Incidentally, ambulances are not always waiting at fire stations. For example, an ambulance may be, for example, on the way back after moving to a scene, which is a position from which the ambulance has been called. In this case, when the ambulance moves to the next scene, a moving route is set between the scene and the current position of the ambulance on the way back.

In view of the fact that the ambulance is on the way back, it is considered that passing through the vicinity of a position where the next call is expected shortens the time of arrival at the next scene.

Non Patent Literature 1 described above discloses contents related to research and development aimed at shortening the time it takes an ambulance to arrive at a scene. However, Non Patent Literature 1 described above does not consider shortening the time of arrival at the scene by setting a waypoint for the ambulance, which is an example of a mobile object.

The disclosed technology has been made in view of the above points, and is aimed at speeding up arrival at a position from which a mobile object has been called by appropriately setting a waypoint of the mobile object.

### Solution to Problem

A first aspect of the present disclosure provides a waypoint setting device including: a waypoint setting unit that sets a waypoint on the basis of a predictive distribution representing a demand prediction of occurrence points indicating positions from which a mobile object is called, position information indicating a position of a target mobile object that is a mobile object for which the waypoint is to be set, and destination information indicating information regarding a destination to which the target mobile object is to be moved; and an output unit that outputs the waypoint set by the waypoint setting unit.

A second aspect of the present disclosure provides a waypoint setting method in which a computer executes processing of: setting a waypoint on the basis of a predictive distribution representing a demand prediction of occurrence points indicating positions from which a mobile object is called, position information indicating a position of a target mobile object that is a mobile object for which the waypoint is to be set, and destination information indicating information regarding a destination to which the target mobile object is to be moved; and outputting the set waypoint.

### Advantageous Effects of Invention

According to the disclosed technology, it is possible to speed up arrival at a position from which the mobile object has been called by appropriately setting a waypoint of the mobile object.

### BRIEF DESCRIPTION OF DRAWINGS

FIG. 1 is a diagram for illustrating an outline of a waypoint setting device according to the present embodiment.

FIG. 2 is a block diagram illustrating a hardware configuration of a waypoint setting device 10.

FIG. 3 is a block diagram illustrating a hardware configuration of a mobile terminal 12.

FIG. 4 is a block diagram illustrating an example of a functional configuration of a moving route setting system 1.

FIG. 5 is a block diagram illustrating an example of a functional configuration of the waypoint setting device 10.

FIG. 6 is a flowchart illustrating a flow of waypoint setting processing by the waypoint setting device 10.

FIG. 7 is a flowchart illustrating a flow of waypoint setting processing by a waypoint setting device 10 according to a second embodiment.

FIG. 8 is a block diagram illustrating an example of a functional configuration of a waypoint setting device 310 according to a third embodiment.

FIG. 9 is a block diagram illustrating an example of a functional configuration of a waypoint setting device 510 according to a fifth embodiment.

FIG. 10 is a diagram illustrating an example of a table used in the fifth embodiment.

FIG. 11 is a diagram illustrating an example of a table used in the fifth embodiment.

FIG. 12 is a diagram for illustrating clustering in the fifth embodiment.

FIG. 13 is a diagram illustrating an example of a table used in the fifth embodiment.

FIG. 14 is a diagram illustrating an example of a table used in the fifth embodiment.

FIG. 15 is a diagram illustrating an example of a table used in the fifth embodiment.

FIG. 16 is a flowchart illustrating a flow of waypoint setting processing by the waypoint setting device 510 according to the fifth embodiment.

FIG. 17 is a flowchart illustrating a flow of waypoint setting processing by a waypoint setting device 510 according to a sixth embodiment.

### DESCRIPTION OF EMBODIMENTS

Hereinafter, an example of an embodiment of the disclosed technology will be described with reference to the drawings. In the drawings, the same or equivalent components and portions are denoted by the same reference numerals. In addition, dimensional ratios in the drawings are exaggerated for convenience of description, and may be different from actual ratios.

Emergency vehicles (for example, ambulances, fire engines, patrol cars, and the like) are desired to arrive at a scene as quickly as possible. In existing technologies, places where the emergency vehicles are placed are optimized so that the time to the scene is shortened.

However, conventional methods do not pay attention to the fact that there is room for optimization of operation also when the emergency vehicles are moving. For example, when consideration is given to an ambulance, on a route to return to a fire station after completing an action for a sick or injured person, it is possible to expect a reduction in time to get to the next scene by passing through an area from which the ambulance is likely to be called or waiting in that area.

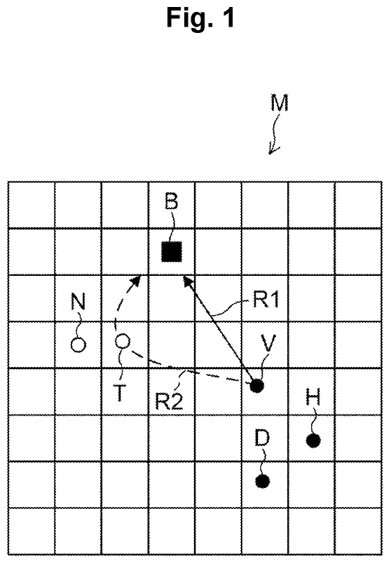

FIG. 1 is a schematic diagram of the present embodiment. In a map M as illustrated in FIG. 1, a case will be considered in which, for example, an ambulance V, which is an example of a mobile object, moves to a place D from which the ambulance V has been called, picks up a sick or injured person at that place, and moves to a hospital H.

Then, it is assumed that the ambulance V drops the sick or injured person off at the hospital H, and makes its way back to a fire station B. In this case, in a case where a place N is expected as the position from which the ambulance V is called next, the ambulance V can arrive faster at the place N from which the ambulance V is called next by traveling on a route R2 passing through a waypoint T than by traveling on a route R1.

Thus, in the present embodiment, an appropriate waypoint of an ambulance is set. This speeds up arrival of the ambulance at the position from which the ambulance has been called.

In the present embodiment, a case where the mobile object is an ambulance will be described as an example.

### First Embodiment

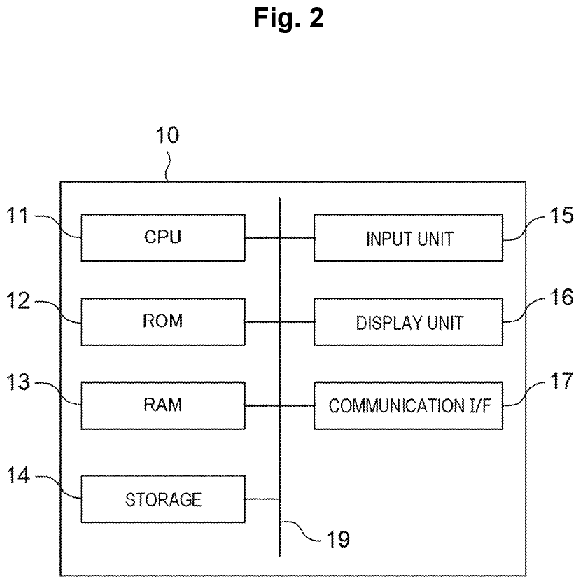

FIG. 2 is a block diagram illustrating a hardware configuration of a waypoint setting device 10.

As illustrated in FIG. 2, the waypoint setting device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 19.

The CPU 11 is a central processing unit, and executes various programs and controls each unit. That is, the CPU 11 reads the program from the ROM 12 or the storage 14, and executes the program using the RAM 13 as a work region. The CPU 11 performs control of each of the above-described components and various types of operation processing according to a program stored in the ROM 12 or the storage 14. In the present embodiment, the ROM 12 or the storage 14 stores a waypoint setting program for setting a moving route of the ambulance.

The ROM 12 stores various programs and various types of data. The RAM 13 temporarily stores programs or data as a work region. The storage 14 includes a storage device such as a hard disk drive (HDD) or a solid state drive (SSD), and stores various programs including an operating system and various types of data.

The input unit 15 includes a pointing device such as a mouse and a keyboard, and is used to perform various inputs.

The display unit 16 is, for example, a liquid crystal display, and displays various types of information. The display unit 16 may function as the input unit 15 by adopting a touch panel system.

The communication interface 17 is an interface for communicating with another device such as a portable terminal. For the communication, for example, a wireless communication standard such as 4G, 5G, or Wi-Fi (registered trademark) is used.

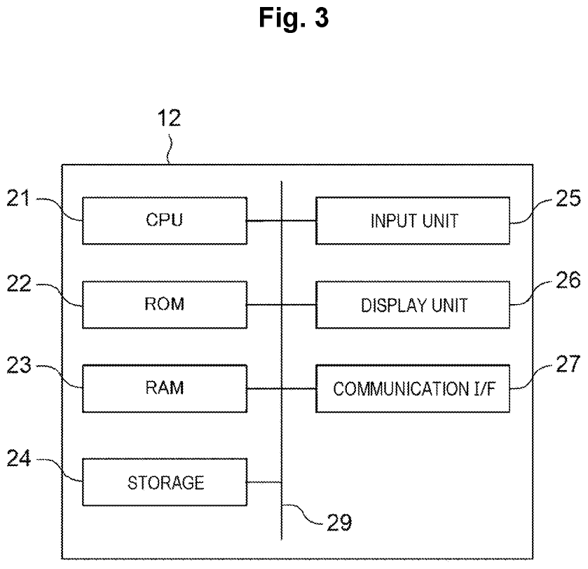

FIG. 3 is a block diagram illustrating a hardware configuration of a mobile terminal 12.

As illustrated in FIG. 3, the mobile terminal 12 includes a central processing unit (CPU) 21, a read only memory (ROM) 22, a random access memory (RAM) 23, a storage 24, an input unit 25, a display unit 26, and a communication interface (I/F) 27. The components are communicably connected to each other via a bus 29.

The CPU 21 is a central processing unit, and executes various programs and controls each unit. That is, the CPU 21 reads the program from the ROM 22 or the storage 24, and executes the program using the RAM 23 as a work region. The CPU 21 performs control of each of the above-described components and various types of operation processing according to a program stored in the ROM 22 or the storage 24. In the present embodiment, various programs are stored in the ROM 22 or the storage 24.

The ROM 22 stores various programs and various types of data. The RAM 23 temporarily stores programs or data as a work region. The storage 24 includes a storage device such as a hard disk drive (HDD) or a solid state drive (SSD), and stores various programs including an operating system and various types of data.

The input unit 25 includes a pointing device such as a mouse and a keyboard, and is used to perform various inputs.

The display unit 26 is, for example, a liquid crystal display, and displays various types of information. The display unit 26 may function as the input unit 25 by adopting a touch panel system.

The communication interface 27 is an interface for communicating with another device such as a portable terminal. For the communication, for example, a wireless communication standard such as 4G, 5G, or Wi-Fi (registered trademark) is used.

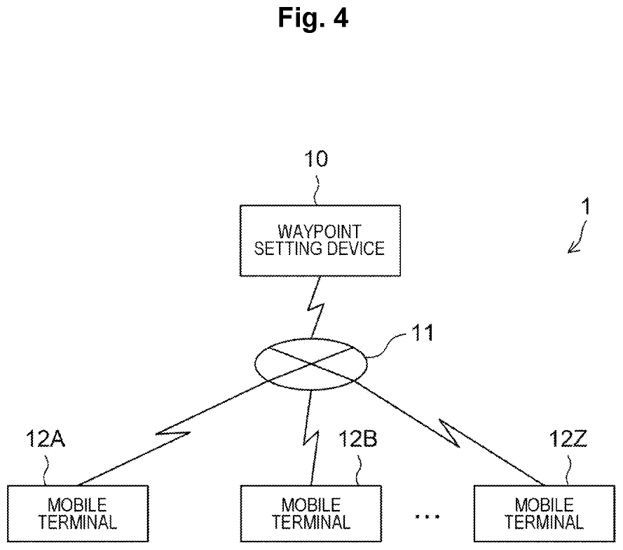

Next, a functional configuration of a moving route setting system 1 will be described. FIG. 4 is a block diagram illustrating an example of the functional configuration of the moving route setting system 1. As illustrated in FIG. 4, the moving route setting system 1 includes the waypoint setting device 10 and a plurality of mobile terminals 12A, 12B, . . . , and 12Z, and the waypoint setting device 10 and the plurality of mobile terminals 12A, 12B, . . . , and 12Z are communicably connected via a network 11 such as the Internet. Note that the plurality of mobile terminals 12A, 12B, . . . , and 12Z is hereinafter simply referred to as the “mobile terminals 12”, except for indicating a specific mobile terminal among the plurality of mobile terminals 12A, 12B, . . . , and 12Z. The waypoint setting device 10 is installed, for example, at a command board or the like, and the mobile terminals 12 are mounted on ambulances.

Next, a functional configuration of the waypoint setting device 10 will be described.

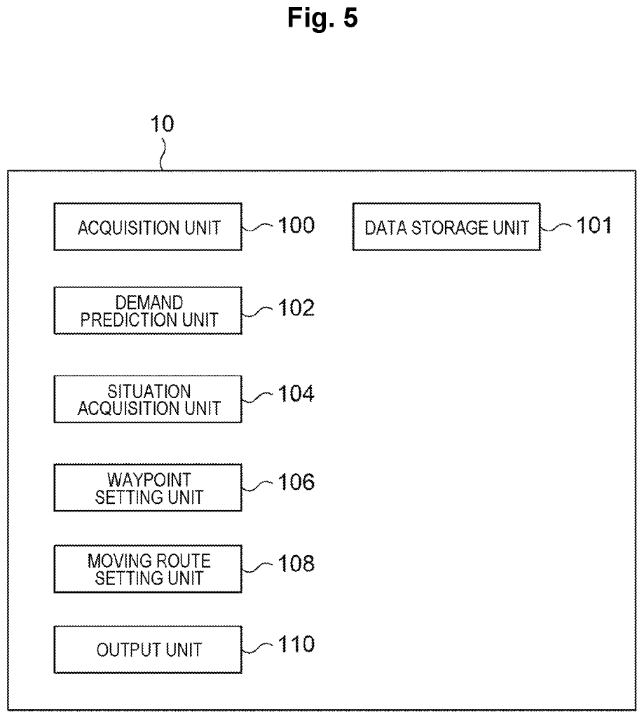

FIG. 5 is a block diagram illustrating an example of the functional configuration of the waypoint setting device 10.

As illustrated in FIG. 5, the waypoint setting device 10 includes, as functional configurations, an acquisition unit 100, a data storage unit 101, a demand prediction unit 102, a situation acquisition unit 104, a waypoint setting unit 106, a moving route setting unit 108, and an output unit 110. Each functional configuration is achieved by the CPU 11 reading a waypoint setting program stored in the ROM 12 or the storage 14, developing the waypoint setting program in the RAM 13, and executing the waypoint setting program.

The acquisition unit 100 acquires various types of data from a command board system (not illustrated) in which various types of data of each one of a plurality of ambulances are collected. Note that the acquisition unit 100 may acquire various types of data from each one of the plurality of mobile terminals 12A, 12B, . . . , and 12Z. In addition, the acquisition unit 100 may acquire various types of data from an external server (not illustrated) different from the command board system. Then, the acquisition unit 100 stores the acquired various types of data in the data storage unit 101.

The data storage unit 101 stores various types of data acquired by the acquisition unit 100. For example, the data stored in the data storage unit 101 includes, for each one of the plurality of ambulances, a dispatch availability status of the ambulance, position information of the ambulance, position information of the fire station to which the ambulance is assigned, identification information of the fire station to which the ambulance is assigned, and occurrence points indicating positions from which the ambulance was called in the past. Thus, new data is stored every moment in the data storage unit 101.

The demand prediction unit 102 generates a predictive distribution representing a demand prediction of occurrence points indicating positions from which the ambulance is called. For example, the predictive distribution is generated from emergency transport information representing a combination of the position and the time the ambulance was called in the past. For example, the emergency transport information filtered by month, time of day, or the like is used as the predictive distribution. For example, when generating a predictive distribution of the first Friday of July, the demand prediction unit 102 extracts information of the first Friday of July last year from the emergency transport information, and generates the predictive distribution on the basis of the information. Thus, the predictive distribution is data regarding a plurality of positions from which the ambulance may be called.

Alternatively, for example, the demand prediction unit 102 may generate the predictive distribution by using a learned model that has been trained in advance by machine learning with the use of emergency transport information, information regarding past population of each place, information regarding past weather of each place, and the like.

For a target ambulance, which is an ambulance for which a moving route is to be set among a plurality of ambulances, the situation acquisition unit 104 acquires, from the data storage unit 101, a dispatch availability status of the target ambulance, position information of the target ambulance, position information of the fire station to which the target ambulance is assigned, identification information of the fire station to which the target ambulance is assigned, and the like.

The waypoint setting unit 106 sets a waypoint for the target ambulance moving to a destination on the basis of the predictive distribution generated by the demand prediction unit 102, position information indicating the position of the target ambulance acquired by the situation acquisition unit 104, and destination information indicating information regarding the destination to which the target ambulance is to be moved. The destination is, for example, the fire station to which the target ambulance is assigned, and to which the target ambulance moves after moving to a place from which the target ambulance has been called and completing the task.

For example, on the basis of the predictive distribution, the position information of the target ambulance, and the destination information of the target ambulance, the waypoint setting unit 106 sets, as a waypoint for the target ambulance, a position that exists in a range set in advance from the position and the destination of the target ambulance and is expected to shorten a distance to an occurrence point from which a call is predicted.

The moving route setting unit 108 sets a moving route between the target ambulance and the destination in such a way that the moving route passes through the waypoint set by the waypoint setting unit 106.

The output unit 110 outputs the moving route set by the moving route setting unit 108.

The moving route output by the output unit 110 is transmitted to the mobile terminal 12 of the target ambulance via the communication interface 17, for example.

The mobile terminal 12 of the target ambulance acquires the moving route. Then, an occupant of the target ambulance checks the moving route displayed on the display unit 26 or the like, and follows the moving route.

Next, actions of the waypoint setting device 10 will be described.

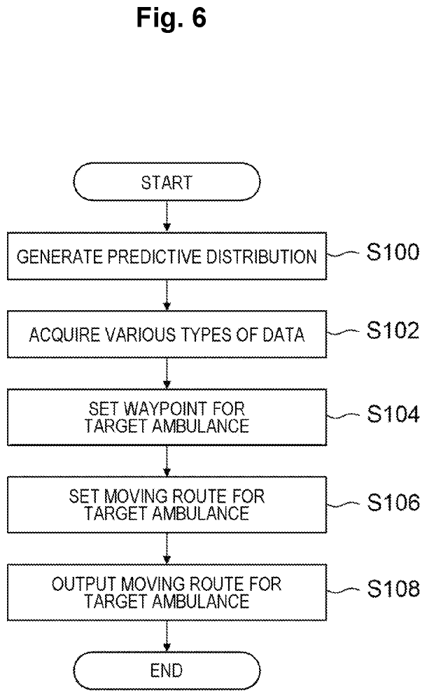

FIG. 6 is a flowchart illustrating a flow of waypoint setting processing by the waypoint setting device 10. The waypoint setting processing is performed by the CPU 11 reading a waypoint setting program from the ROM 12 or the storage 14, developing the waypoint setting program in the RAM 13, and executing the waypoint setting program.

In step S100, the CPU 11, as the demand prediction unit 102, generates a predictive distribution.

In step S102, the CPU 11, as the situation acquisition unit 104, acquires, from the data storage unit 101, a dispatch availability status of the target ambulance, position information of the target ambulance, position information of the fire station to which the target ambulance is assigned, and identification information of the fire station to which the target ambulance is assigned.

In step S104, the CPU 11, as the waypoint setting unit 106, sets a waypoint for the target ambulance moving to a destination on the basis of the predictive distribution generated in step S100 described above, the position information indicating the position of the target ambulance acquired in step S102 described above, and destination information indicating information regarding the destination to which the target ambulance is to be moved.

In step S106, the CPU 11, as the moving route setting unit 108, sets a moving route between the target ambulance and the destination in such a way that the moving route passes through the waypoint set in step S104 described above.

In step S108, the CPU 11, as the output unit 110, outputs the moving route set in step S106 described above.

As described above, on the basis of a predictive distribution indicating a demand prediction of positions from which the ambulance is called and position information indicating the position of a target ambulance, which is an ambulance for which a moving route is to be set, the waypoint setting device 10 according to a first embodiment sets a waypoint for the target ambulance moving to a destination. Then, the waypoint setting device 10 sets a moving route between the target ambulance and the destination in such a way that the moving route passes through the set waypoint, and outputs the set moving route. This speeds up arrival at a position from which the ambulance has been called.

### Second Embodiment

Next, a second embodiment will be described. The second embodiment is different from the first embodiment in that a moving route is reset in a case where a preset condition is satisfied. Note that a waypoint setting device according to the second embodiment has a configuration similar to that of the first embodiment, and the same reference numerals are given and description thereof is omitted.

For example, a waypoint setting unit 106 or a moving route setting unit 108 according to the second embodiment resets a waypoint or a moving route for a target ambulance in a case where a preset condition is satisfied.

For example, in a case where a predetermined time has elapsed since the previous waypoint setting, the moving route setting unit 108 according to the second embodiment resets the waypoint for the target ambulance. Thus, in a case where the predetermined time has not elapsed since the previous waypoint setting, the waypoint is not reset.

Alternatively, for example, in a case where a predetermined time has elapsed since dispatch of the target ambulance, the moving route setting unit 108 according to the second embodiment sets a moving route for moving to the fire station to which the target ambulance is assigned (or another fire station), which is the final destination. For example, in a case where the target ambulance is dispatched and passes through the waypoint, and then 60 minutes elapses, if there is no call for the ambulance from around the target ambulance, a moving route for moving to the fire station to which the target ambulance is assigned (or another fire station), which is the final destination, is set, and the target ambulance moves to the final destination.

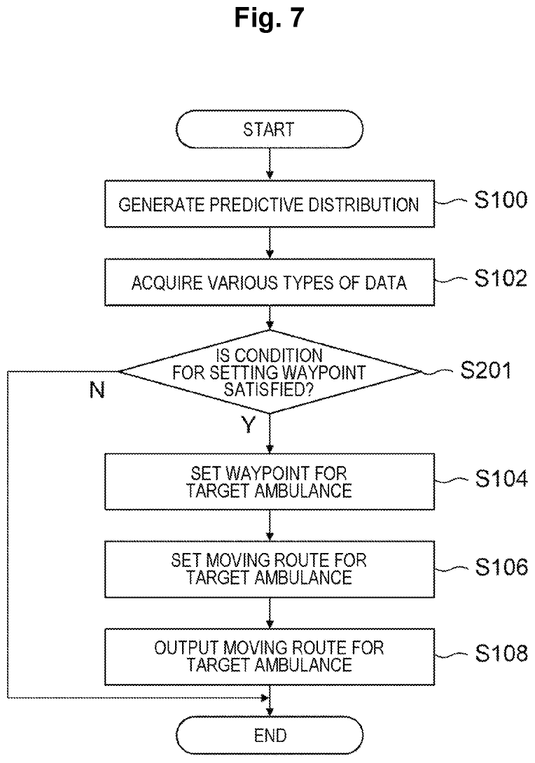

FIG. 7 is a flowchart illustrating a flow of waypoint setting processing by a waypoint setting device 10 according to the second embodiment. The waypoint setting processing is performed by a CPU 11 reading a waypoint setting program from a ROM 12 or a storage 14, developing the waypoint setting program in a RAM 13, and executing the waypoint setting program.

In steps S100 to S102 and steps S104 to S108, processing similar to that in the first embodiment is performed.

In step S201, the waypoint setting unit 106 according to the second embodiment determines whether a preset condition is satisfied. In a case where the preset condition is satisfied, the processing proceeds to step S104. On the other hand, in a case where the preset condition is not satisfied, the processing ends.

Note that other configurations and actions of the waypoint setting device according to the second embodiment are similar to those of the first embodiment, and thus, description thereof is omitted.

As described above, the waypoint setting device 10 according to the second embodiment resets a waypoint or a moving route in a case where a preset condition is satisfied. As a result, in a case where the preset condition is satisfied, a waypoint or a moving route is set, and arrival at a position from which the ambulance has been called can be speeded up.

### Third Embodiment

Next, a third embodiment will be described. The third embodiment is different from the first embodiment and the second embodiment in that a state of each one of a plurality of ambulances is predicted and a waypoint is set in accordance with a result of the prediction. Note that parts having configurations similar to those of the first embodiment or the second embodiment are denoted by the same reference numerals, and description thereof is omitted.

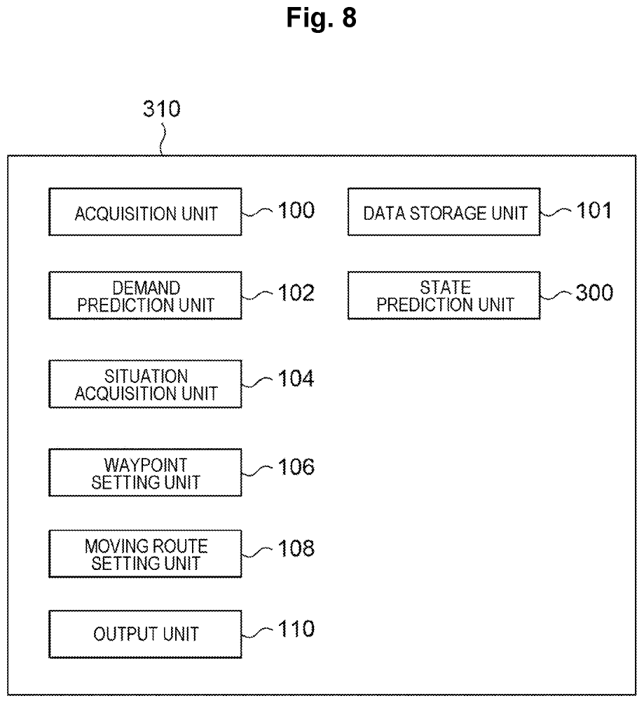

FIG. 8 is a block diagram illustrating an example of a functional configuration of a waypoint setting device 310 according to the third embodiment.

As illustrated in FIG. 8, the third waypoint setting device 310 includes, as functional configurations, an acquisition unit 100, a data storage unit 101, a demand prediction unit 102, a situation acquisition unit 104, a waypoint setting unit 106, a moving route setting unit 108, an output unit 110, and a state prediction unit 300. Each functional configuration is achieved by a CPU 11 reading a waypoint setting program stored in a ROM 12 or a storage 14, developing the waypoint setting program in a RAM 13, and executing the waypoint setting program.

The state prediction unit 300 predicts, for each one of a plurality of ambulances different from a target ambulance, states of the plurality of ambulances different from the target ambulance after a predetermined time, on the basis of history information regarding a history of the ambulance. For example, the state prediction unit 300 sets, for an ambulance in which a certain period of time has elapsed since a call, a flag indicating that the ambulance will soon be ready to respond to the next call, thereby predicting the state of the ambulance. In this case, the state prediction unit 300 predicts the state of the ambulance on the basis of information regarding the time and place the ambulance was called, the information being stored in the data storage unit 101.

In addition, for example, the state prediction unit 300 may predict, for each one of a plurality of ambulances different from the target ambulance, the position of the ambulance as the state of the ambulance.

The waypoint setting unit 106 according to the third embodiment sets a waypoint for the target ambulance on the basis of the states of a plurality of ambulances different from the target ambulance predicted by the state prediction unit 300. For example, in accordance with a prediction result that the dispatch availability status of an ambulance different from the target ambulance will change from “unavailable” to “available” after a predetermined time, the waypoint setting unit 106 assumes that a certain region is covered by that ambulance and calculates a waypoint for the target ambulance. For example, a case will be considered in which occurrence points are uniformly distributed in an area of a square region. In this case, on the basis of a result of prediction of the state of another ambulance different from the target ambulance, in a case where a lower right area as viewed from the center of the square region will soon be covered by the other ambulance different from the target ambulance, a waypoint for the target ambulance is set in an upper left area as viewed from the center of the square region. As a result, the waypoint for the target ambulance is appropriately set, and a wide region is covered by a plurality of ambulances.

Note that other configurations and actions of the waypoint setting device according to the third embodiment are similar to those of the first embodiment or the second embodiment, and thus, description thereof is omitted.

As described above, the waypoint setting device 310 according to the third embodiment sets a waypoint for the target ambulance in accordance with a result of prediction of the states of ambulances different from the target ambulance. As a result, the waypoint is appropriately set in accordance with the result of prediction of the states of the ambulances different from the target ambulance, and arrival at a position from which the ambulance has been called can be speeded up.

### Fourth Embodiment

Next, a fourth embodiment will be described. The fourth embodiment is different from the first to third embodiments in that a waypoint is set in consideration of a change in placement of an ambulance. Note that a waypoint setting device according to the fourth embodiment has a configuration similar to that of the first embodiment, and the same reference numerals are given and description thereof is omitted.

There is a case where the placement of the ambulance is changed. For example, there is a case where the ambulance waits at another fire station different from the fire station to which the ambulance is assigned in preparation for dispatch for a call made in the vicinity of the other fire station.

However, in a case where there is no space for placement of the ambulance or the like in the other fire station, the placement of the ambulance cannot be changed to the other fire station.

On the other hand, in a case where the placement of the ambulance can be changed, setting a waypoint also for the ambulance moving for the change in placement from the fire station to which the ambulance is assigned to the other fire station allows the ambulance to arrive at a scene quickly also in a case where a call is made during the change in placement.

A waypoint setting unit 106 according to the fourth embodiment therefore sets, as a final destination, the other fire station different from the fire station to which the target ambulance is assigned, and sets a waypoint for moving from the fire station to which the target ambulance is assigned to the final destination.

As a result, even in a case where the placement of the ambulance cannot be changed due to some circumstances, it is possible to shorten the arrival time at the next scene by, for example, setting a waypoint for the ambulance returning to the fire station to which the ambulance is assigned. In addition, in a case where the placement of the ambulance can be changed, it is possible to shorten the arrival time at the next scene by setting a waypoint on the way to the fire station to which the placement is to be changed.

Note that other configurations and actions of the waypoint setting device according to the fourth embodiment are similar to those of any one of the first embodiment to the third embodiment, and thus, description thereof is omitted.

As described above, a waypoint setting device 10 according to the fourth embodiment sets, as a final destination, the other fire station different from the fire station to which the target ambulance is assigned, and sets a waypoint on a moving route from the fire station to which the target ambulance is assigned to the final destination. As a result, even in a case where the placement of the ambulance cannot be changed, arrival at a position from which the ambulance has been called can be speeded up. In addition, in a case where the placement of the ambulance can be changed, it is possible to speed up arrival at a position from which the ambulance has been called by setting a waypoint for the ambulance moving for the change in placement.

### Fifth Embodiment

Next, a fifth embodiment will be described. The fifth embodiment is different from the first to fourth embodiments in that clustering is performed on each of occurrence points indicating positions from which the ambulance was called in the past on a virtual map, using each one of a plurality of ambulances as the center of a cluster. Note that parts having configurations similar to those of the first to fourth embodiments are denoted by the same reference numerals, and description thereof is omitted.

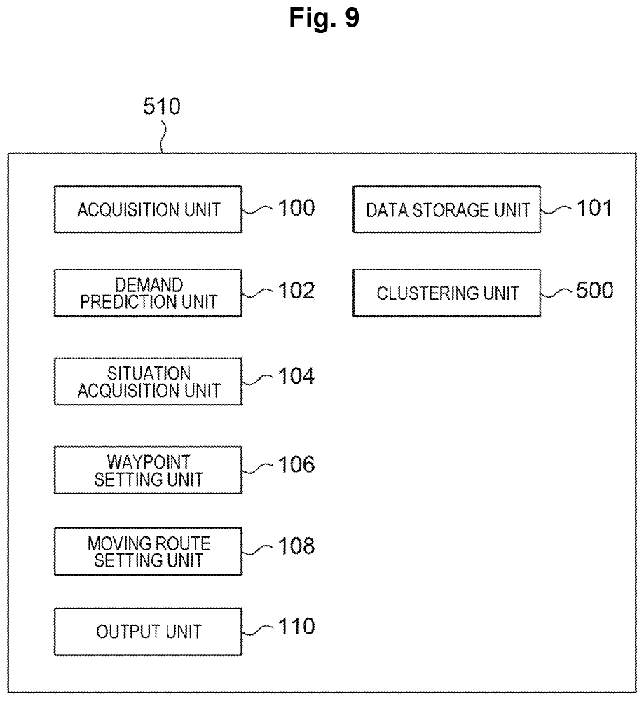

FIG. 9 is a block diagram illustrating an example of a functional configuration of a waypoint setting device 510 according to the fifth embodiment.

As illustrated in FIG. 9, the waypoint setting device 510 according to the fifth embodiment includes, as functional configurations, an acquisition unit 100, a data storage unit 101, a demand prediction unit 102, a situation acquisition unit 104, a waypoint setting unit 106, a moving route setting unit 108, an output unit 110, and a clustering unit 500. Each functional configuration is achieved by a CPU 11 reading a waypoint setting program stored in a ROM 12 or a storage 14, developing the waypoint setting program in a RAM 13, and executing the waypoint setting program.

The waypoint setting device 510 according to the fifth embodiment clusters each of occurrence points indicating positions from which the ambulance was called in the past using a method obtained by improving k-means clustering, which is a known clustering method. Note that, at this time, the waypoint setting device 510 according to the fifth embodiment performs clustering, using each one of a plurality of ambulances as the center of a cluster. Then, the waypoint setting device 510 according to the fifth embodiment sets the center of a specific cluster obtained by the clustering as a waypoint for a target ambulance.

In the fifth embodiment, a waypoint is set in a range that allows the target ambulance to arrive at a fire station as a destination within a designated time. In addition, in the fifth embodiment, in a case where the time required is shorter than the designated time, the target ambulance waits at the waypoint for a period of time by which the time required is shorter, and a moving route is output to the target ambulance only once.

The situation acquisition unit 104 according to the fifth embodiment acquires, from the data storage unit 101 for each one of a plurality of ambulances, the dispatch availability status of the ambulance and the position information of the ambulance.

On the basis of the data acquired by the situation acquisition unit 104, the clustering unit 500 extracts, from each one of the plurality of ambulances, a target ambulance, which is an ambulance for which a waypoint is to be set, an on-the-way ambulance, which is an ambulance on the way to the waypoint or already positioned at the waypoint, and a waiting ambulance, which is an ambulance waiting at a fire station, which is an example of a base.

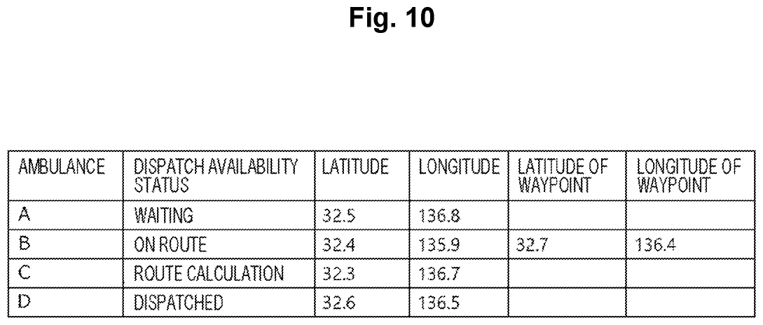

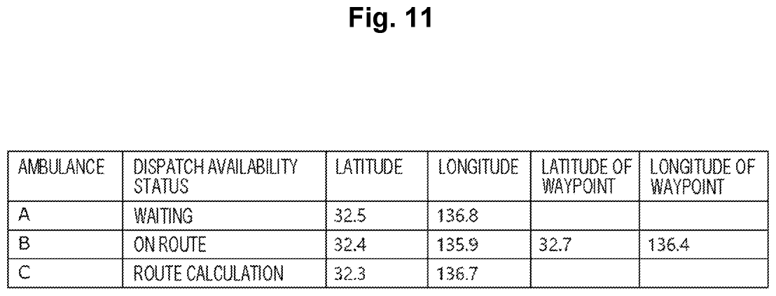

Next, the clustering unit 500 sets each of the target ambulance, the on-the-way ambulance, and the waiting ambulance as the center of one of a plurality of clusters on the virtual map. For example, the clustering unit 500 extracts position information of each of the target ambulance, the on-the-way ambulance, and the waiting ambulance by extracting data as illustrated in FIG. 11 from data as illustrated in FIG. 10.

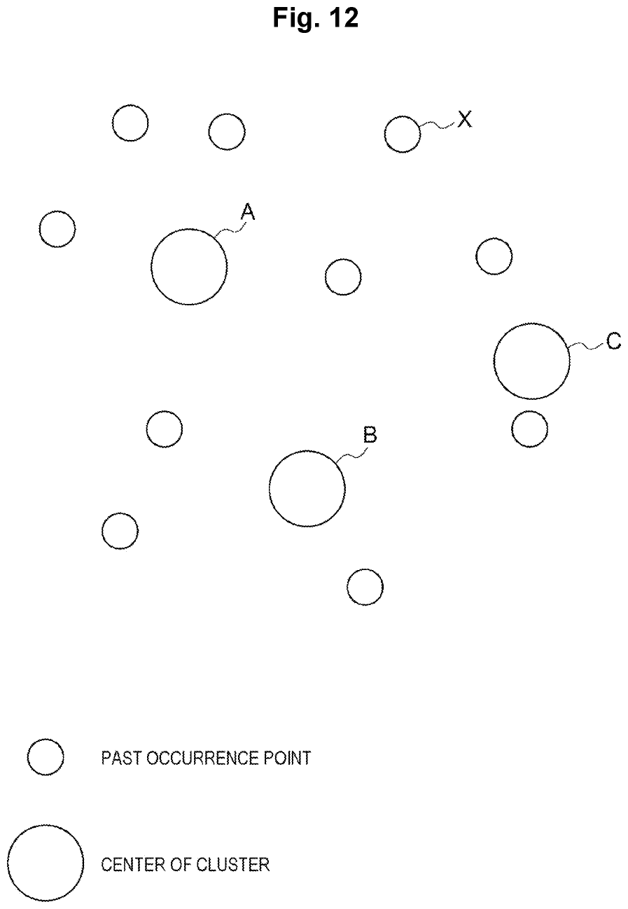

FIG. 12 illustrates a diagram for illustrating clustering. As illustrated in FIG. 12, centers A, B, and C of the corresponding clusters are set on a virtual map. First, the clustering unit 500 sets an initial position of the target ambulance to the position of the fire station to which the target ambulance is assigned. Note that the initial position may be set by any method. Next, in a case where the on-the-way ambulance is moving to a waypoint, the clustering unit 500 sets the initial position to the waypoint for the on-the-way ambulance, and in a case where the on-the-way ambulance is moving to a fire station, the clustering unit 500 sets the initial position to the position of the fire station. Note that the current position of the on-the-way ambulance is acquired from the data storage unit 101. Then, the position of each of the centers A, B, and C of the corresponding clusters is updated by processing to be described later, so that the positions allow a plurality of occurrence points X to be covered, and the placement of the ambulance becomes appropriate.

Next, the clustering unit 500 acquires, from the data storage unit 101, each of the occurrence points indicating positions from which the ambulance was called in the past.

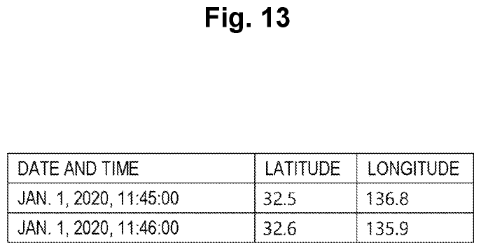

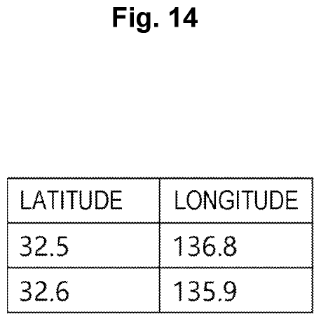

Next, the clustering unit 500 extracts, from each one of the plurality of occurrence points, each of occurrence points corresponding to the time of day for which a waypoint is to be set now. For example, the clustering unit 500 extracts data as illustrated in FIG. 14 from data as illustrated in FIG. 13, thereby extracting each of occurrence points in a period in which occurrence tendencies are likely to be similar, such as the same time of day in the same month of the previous year.

Next, the clustering unit 500 sets, from each of the occurrence points extracted in the above description, each of occurrence points that exist in a range that allows the target ambulance to arrive at the destination within the designated time also by passing through the occurrence point, and gives each of the set occurrence points a flag indicating that the target ambulance can arrive at the destination within the designated time. This flag is used when the position of the ambulance is updated.

Next, the clustering unit 500 allocates each of the occurrence points extracted in the above description to any one of a plurality of clusters. Note that the clustering unit 500 allocates each of the occurrence points to any one of the plurality of clusters by performing calculation using a method of allocation to a cluster in the known k-means clustering. Specifically, for each of the occurrence points, the clustering unit 500 obtains the center of a cluster closest to the occurrence point, and the occurrence point is assumed to be assigned to a cluster at the center of that cluster.

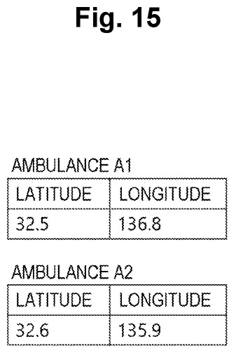

Next, the clustering unit 500 updates the position of the center of the cluster corresponding to the target ambulance on the basis of the result of allocation of each of the occurrence points extracted in the above description to a cluster. Note that the clustering unit 500 updates the position of the center of the cluster corresponding to the target ambulance by performing calculation using a method of updating the position of the center of the cluster in the known k-means clustering. Specifically, the clustering unit 500 updates the position of the center of the cluster corresponding to the target ambulance with the center of gravity of an occurrence point, among a plurality of occurrence points assigned to the cluster, with a flag indicating that the target ambulance can arrive at the destination within the designated time also by passing through the occurrence point. With the update by the clustering unit 500, for example, the positions (latitude and longitude in FIG. 15) of the centers of the clusters of the target ambulances A1 and A2 are updated as illustrated in FIG. 15.

Note that the clustering unit 500 updates only the position of the center of the cluster corresponding to the target ambulance. For an on-the-way ambulance, a waypoint or a destination has already been determined, and for a waiting ambulance, the fire station where the ambulance is waiting has already been determined. For this reason, the clustering unit 500 does not update the positions of the centers of the clusters corresponding to the on-the-way ambulance and the waiting ambulance since the occurrence points to be covered by the on-the-way ambulance and the waiting ambulance have already been determined. On the other hand, the clustering unit 500 updates the position of the center of the cluster of a target ambulance, which is an ambulance for which a waypoint is to be set now. As a result, a range that cannot be covered by the on-the-way ambulance and the waiting ambulance is covered by the target ambulance.

Then, the clustering unit 500 repeats allocation of each of occurrence points to a cluster and update of the position of the center of the cluster corresponding to the target ambulance. Note that the clustering unit 500 repeats allocation of each of occurrence points to a cluster and update of the position of the center of the cluster corresponding to the target ambulance until a clustering termination condition is satisfied. For example, as the clustering termination condition, a condition such as whether the clustering has been repeated the number of times set in advance or whether movement of the center of the cluster does not exceed a predetermined value.

The waypoint setting unit 106 according to the fifth embodiment sets, as a waypoint for the target ambulance, the position of the center of the cluster corresponding to the target ambulance obtained as a result of clustering by the clustering unit 500.

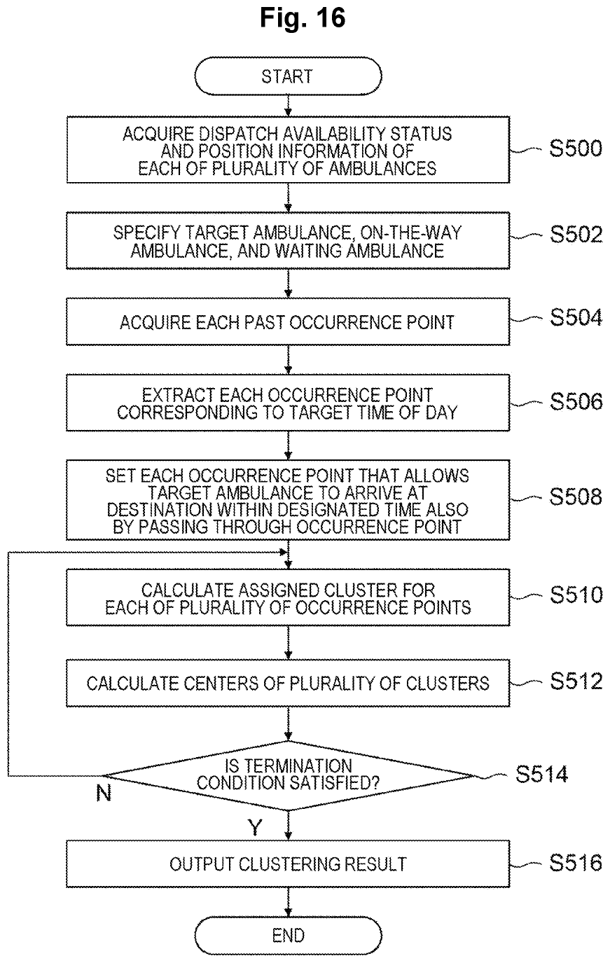

FIG. 16 is a flowchart illustrating a flow of waypoint setting processing by the waypoint setting device 510 according to the fifth embodiment. The waypoint setting processing is performed by the CPU 11 reading a waypoint setting program from the ROM 12 or the storage 14, developing the waypoint setting program in the RAM 13, and executing the waypoint setting program. The flowchart illustrated in FIG. 16 illustrates only clustering processing included in the waypoint setting processing.

In step S500, the CPU 11, as the clustering unit 500, acquires, from the data storage unit 101, a dispatch availability status and position information of each one of a plurality of ambulances.

In step S502, the CPU 11, as the clustering unit 500, specifies a target ambulance, an on-the-way ambulance, and a waiting ambulance from each one of the plurality of ambulances on the basis of the dispatch availability status and the position information of each one of the plurality of ambulances acquired in step S500 described above.

In step S504, the CPU 11, as the clustering unit 500, acquires each of past occurrence points from the data storage unit 101.

In step S506, the CPU 11, as the clustering unit 500, extracts, from each one of the plurality of occurrence points acquired in step S504 described above, each of occurrence points corresponding to the time of day for which a waypoint is to be set now.

In step S508, the CPU 11, as the clustering unit 500, sets each of occurrence points, from each one of the plurality of occurrence points extracted in step S506 described above, that exist in a range that allows the target ambulance to arrive at the destination within the designated time also by passing through the occurrence point, and gives a flag.

In step S510, for each one of the plurality of occurrence points extracted in step S506 described above, the CPU 11, as the clustering unit 500, calculates a cluster to which the occurrence point is assigned on the basis of a positional relationship between the position of the occurrence point and the positions of the centers of a plurality of clusters.

In step S512, for each one of the plurality of occurrence points extracted in step S506 described above, the CPU 11, as the clustering unit 500, calculates the center of the cluster corresponding to the target ambulance on the basis of each of the positions of the occurrence points calculated in step S510.

In step S514, the CPU 11, as the clustering unit 500, determines whether a preset termination condition is satisfied. In a case where the termination condition is satisfied, the processing proceeds to step S516. On the other hand, in a case where the termination condition is not satisfied, the processing returns to step S510.

In step S516, the CPU 11, as the clustering unit 500, outputs a clustering result obtained in steps S510 to

S512 described above.

Then, the waypoint setting unit 106 sets the position of the center of the cluster corresponding to the target ambulance obtained as a result of the clustering described above as a waypoint for the target ambulance.

Note that other configurations and actions of the waypoint setting device according to the fifth embodiment are similar to those of any one of the first embodiment to the fourth embodiment, and thus, description thereof is omitted.

As described above, the waypoint setting device 510 according to the fifth embodiment clusters each of occurrence points indicating positions from which the ambulance was called in the past, using each one of a plurality of ambulances as the center of a cluster. Specifically, the waypoint setting device 510 according to the fifth embodiment extracts, from each one of the plurality of ambulances, the target ambulance, an on-the-way ambulance, which is an ambulance on the way to the waypoint or already positioned at the waypoint, and a waiting ambulance, which is an ambulance waiting at a base. Next, the waypoint setting device 510 according to the fifth embodiment sets each of the target ambulance, the on-the-way ambulance, and the waiting ambulance as the center of one of the plurality of clusters. Next, the waypoint setting device 510 according to the fifth embodiment allocates each of occurrence points indicating positions from which the ambulance was called in the past to any one of the plurality of clusters. Next, the waypoint setting device 510 according to the fifth embodiment updates the position of the center of the cluster corresponding to the target ambulance on the basis of the result of allocation of each of the occurrence points to a cluster. Then, the waypoint setting device 510 according to the fifth embodiment repeats allocation of each of occurrence points to a cluster and update of the position of the center of the cluster corresponding to the target ambulance. The waypoint setting device 510 according to the fifth embodiment sets the position of the center of the cluster corresponding to the target ambulance obtained as a result of the clustering as a waypoint for the target ambulance. This speeds up arrival at a position from which the ambulance has been called.

In addition, the waypoint setting device 510 according to the fifth embodiment allows the target ambulance to arrive at a destination (for example, a fire station) within a designated time by extracting, from each one of the plurality of occurrence points, each of occurrence points that exist in a range that allows the target ambulance to arrive at the destination within the designated time also by passing through the occurrence point. That is, by this processing, it is possible to set a waypoint in a range in which the time during which the target ambulance can exist on the moving route is ensured.

In addition, the waypoint setting device 510 according to the fifth embodiment updates only the position of the center of the cluster corresponding to the target ambulance for which a moving route is to be obtained, but does not update the positions of the centers of the clusters corresponding to the on-the-way ambulance and the waiting ambulance, which are other ambulances. As a result, it is possible to appropriately set a waypoint for the target ambulance, taking into consideration the range covered by the on-the-way ambulance already existing on the moving route and the waiting ambulance waiting at the fire station.

### Sixth Embodiment

Next, a sixth embodiment will be described. The sixth embodiment is different from the first to fifth embodiments in that a probability that an ambulance at the center of a cluster disappears is taken into consideration when each of occurrence points is clustered with the use of a method obtained by improving the k-means clustering, which is a known clustering method. Note that a waypoint setting device according to the sixth embodiment has a configuration similar to that of the fifth embodiment, and the same reference numerals are given and description thereof is omitted.

When allocating each of occurrence points to any one of a plurality of clusters, a clustering unit 500 according to the sixth embodiment calculates, for each one of a plurality of ambulances, a probability Pₙ (n=1, 2, . . . , N) that the ambulance moves and the center of the cluster corresponding to that ambulance disappears. Note that N is the number of ambulances that are ready to respond to an emergency call.

Even in a case where the ambulance is positioned at a fire station or a waypoint, when the ambulance is called from the vicinity thereof, that ambulance is dispatched and disappears from the fire station or the waypoint, and this needs to be taken into consideration.

Thus, the clustering unit 500 according to the sixth embodiment executes clustering in consideration of the probability that the ambulance at the center of the cluster disappears. Specifically, the clustering unit 500 increases the probability that the center of a cluster corresponding to an ambulance that is likely to be dispatched disappears, and decreases the probability that the center of a cluster corresponding to an ambulance that is less likely to be dispatched disappears.

More specifically, the clustering unit 500 uses each of past occurrence points stored in a data storage unit 101 to calculate the probability of disappearance of the center of a cluster corresponding to an ambulance.

For example, the clustering unit 500 sets a value obtained by dividing the number of occurrence points that belong to a cluster at the center of a target cluster by a preset constant as the probability of disappearance of the center of the cluster. In a case where the value obtained by dividing the number of occurrence points that belong to the cluster by the preset constant becomes 1 or more, for example, a value of 0 or more and less than 1 is substituted. As a result, the probability of disappearance increases as the number of past occurrence points assigned to the cluster increases, and thus a probability representing the actual state is obtained. As a result, in the processing to be described later, a waypoint for the target ambulance is set in consideration of the ease of dispatch of the ambulance.

Next, for each one of the plurality of occurrence points, the clustering unit 500 obtains a cluster assignment probability, which is a probability that the cluster belongs to each cluster, by using a probability that the center of the cluster disappears. For example, when each of the occurrence points is allocated to any one of a plurality of clusters, the clustering unit 500 multiplies a probability Pₓ that the center of a cluster of an ambulance x disappears by a probability (1−P_{y}) that the center of a cluster of an ambulance y does not disappear, thereby calculating a cluster assignment probability representing the probability that the occurrence point is assigned to the cluster of the other ambulance.

By multiplying the probability Pₓ by the probability (1−P_{y}), it is represented that, in a situation where the ambulance x, which is one of the ambulances, is dispatched and the ambulance y, which is the other ambulance, is not dispatched, an occurrence point that has been originally assigned to the cluster of the ambulance x is assigned to the cluster of the ambulance y.

Here, for example, a case will be considered in which there are three ambulances x, y, and z. In this case, probabilities that the ambulances x, y, and z disappear are expressed by Pₓ, P_{y}, and P_{z}, respectively. It is assumed that distances between a certain occurrence point and the ambulances x, y, and z are shorter in the order of x, y, and z. In this case, since the probability that the ambulance x does not disappear is 1−Pₓ, the cluster assignment probability that this occurrence point belongs to the cluster of the ambulance x is 1−Pₓ. On the other hand, the cluster assignment probability that the ambulance x disappears and this occurrence point belongs to the cluster of the ambulance y is Pₓ (1−P_{y}). In addition, the cluster assignment probability that the ambulances x and y disappear and the occurrence point belongs to the cluster of the ambulance z is PₓP_{y} (1−P_{z}). In this way, a cluster assignment probability representing which occurrence point is allocated to which cluster is calculated.

Next, when updating the position of the center of the cluster corresponding to the target ambulance, the clustering unit 500 updates the position of the center of the cluster corresponding to the target ambulance on the basis of each of the cluster assignment probabilities and each of the positions of the occurrence points.

Specifically, the clustering unit 500 updates the position of a center i of the cluster according to the following Formula (1). Note that Si in the following formula is a set of occurrence points extracted for setting a waypoint for the target ambulance corresponding to the cluster i.

$$[ Math . 1 ]$$

$$( 1 )$$

$$Center position of cluster i = \frac{{\sum }_{i ∈ Si} ( \begin{matrix}Cluster assignment probability that occurence point j \\ is assigned to cluster i \times \\ Coordinates of occurrence point j\end{matrix} )}{{\sum }_{i ∈ Si} \begin{matrix}Cluster assignment probability that occurence point j \\ is assigned to cluster i\end{matrix}}$$

Then, as in the fifth embodiment, the clustering unit 500 repeats allocation of each of occurrence points to a cluster and update of the position of the center of the cluster corresponding to the target ambulance.

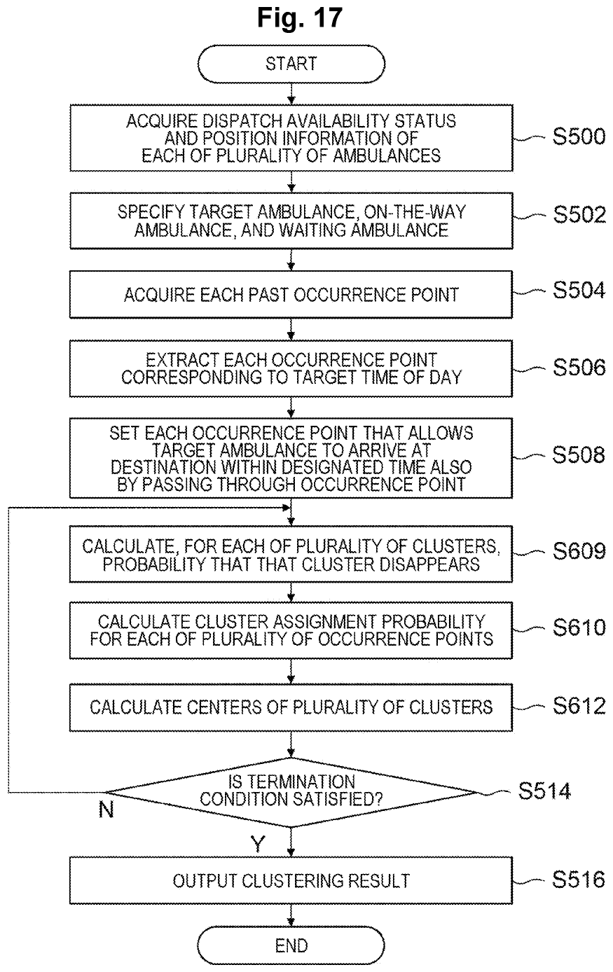

FIG. 17 is a flowchart illustrating a flow of waypoint setting processing by a waypoint setting device 510 according to the sixth embodiment. The waypoint setting processing is performed by a CPU 11 reading a waypoint setting program from a ROM 12 or a storage 14, developing the waypoint setting program in a RAM 13, and executing the waypoint setting program. The flowchart illustrated in FIG. 17 illustrates only clustering processing included in the waypoint setting processing.

Steps S500 to S508 and steps S514 to S516 are executed similarly to those in the fifth embodiment.

In step S609, the CPU 11, as the clustering unit 500, calculates, for each of the clusters corresponding to the ambulances, the probability Pₙ (n=1, 2, . . . , N) that the ambulance moves and the center of the cluster corresponding to that ambulance disappears. Note that the probability Pₙ that the center of the cluster disappears is, for example, a value obtained by dividing the number of occurrence points that belong to the cluster by a preset constant.

In step S610, when allocating each of the occurrence points to any one of the plurality of clusters, the CPU 11, as the clustering unit 500, calculates a cluster assignment probability representing the probability that the occurrence point is assigned to the cluster of the ambulance on the basis of the probability Pₙ that the center of the cluster disappears calculated in step S609 described above.

In step S612, when updating the position of the center of the cluster corresponding to the target ambulance, the CPU 11, as the clustering unit 500, updates the position of the center of the cluster corresponding to the target ambulance on the basis of each of the cluster assignment probabilities calculated in step S610 described above and each of the positions of the past occurrence points.

Note that other configurations and actions of the waypoint setting device according to the sixth embodiment are similar to those of any one of the first embodiment to the fifth embodiment, and thus, description thereof is omitted.

As described above, when allocating each of occurrence points to any one of a plurality of clusters, the waypoint setting device 510 according to the sixth embodiment calculates, for each one of a plurality of ambulances, the probability Pₙ (n=1, 2, . . . , N) that the ambulance moves and the center of the cluster corresponding to the ambulance disappears. In addition, the waypoint setting device 510 according to the sixth embodiment calculates a cluster assignment probability representing the probability that the occurrence point is assigned to the cluster of the ambulance on the basis of the probability Pₙ that the center of the cluster disappears. When updating the position of the center of the cluster corresponding to the target ambulance, the waypoint setting device 510 according to the sixth embodiment updates the position of the center of the cluster corresponding to the target ambulance on the basis of each of the cluster assignment probabilities and each of the positions of the occurrence points. Then, the waypoint setting device 510 according to the sixth embodiment repeats allocation of each of occurrence points to a cluster and update of the position of the center of the cluster corresponding to the target ambulance. This speeds up arrival at a position from which the ambulance has been called.

In addition, the waypoint setting device 510 according to the sixth embodiment determines the probability that the cluster disappears in accordance with the number of occurrence points assigned the cluster. Specifically, the waypoint setting device 510 according to the sixth embodiment increases the probability of disappearance in a case where the number of occurrence points assigned the cluster is larger, and decreases the probability of disappearance in a case where the number of occurrence points is smaller. As a result, it is possible to appropriately consider an ambulance that is likely to be dispatched and an ambulance that is less likely to be dispatched.

In addition, the waypoint setting device 510 according to the sixth embodiment updates only the position of the center of the cluster corresponding to the target ambulance for which a moving route is to be obtained, but does not update the positions of the centers of the clusters corresponding to the on-the-way ambulance and the waiting ambulance, which are other ambulances. As a result, it is possible to appropriately set a waypoint for the target ambulance, taking into consideration the range covered by the on-the-way ambulance already existing on the moving route and the waiting ambulance waiting at the fire station.

In addition, the waypoint setting device 510 according to the sixth embodiment uses the assignment probability of being assigned to each cluster for updating the position of the center of the cluster, so that the center of another cluster easily gets closer to an occurrence point that exists near the center of a cluster that is likely to disappear. As a result, past occurrence points can be appropriately covered by a plurality of ambulances.

The waypoint setting processing, which is performed by the CPU reading software (program) in each of the above embodiments, may be performed by various processors other than the CPU. Examples of the processor in this case include a programmable logic device (PLD) in which a circuit configuration can be changed after manufacturing such as a field-programmable gate array (FPGA), and a dedicated electric circuit that is a processor having a circuit configuration exclusively designed for performing specific processing such as an application specific integrated circuit (ASIC). In addition, the waypoint setting processing may be performed by one of these various processors, or may be performed by a combination of two or more processors of the same type or different types (for example, a plurality of FPGAs, a combination of a CPU and an FPGA, and the like). In addition, the hardware structure of these various processors is, more specifically, an electric circuit in which circuit elements such as semiconductor elements are combined.

In each of the above embodiments, the aspect in which the waypoint setting program is stored (installed) in advance in the storage 14 has been described, but this is not restrictive. The program may be provided in a form stored in a non-transitory storage medium such as a compact disk read only memory (CD-ROM), a digital versatile disk read only memory (DVD-ROM), and a universal serial bus (USB) memory. The program may be downloaded from an external device via a network.

In each of the above embodiments, the case where mobile objects are ambulances has been described as an example, but this is not restrictive. For example, each of the above embodiments may be appropriately applied to other emergency vehicles such as patrol by a police vehicle and dispatch of a fire vehicle. In addition, each of the above embodiments is not limited to emergency vehicles, and may be applied to, for example, a case where mobile objects are dispatched for a certain demand such as delivery of prepared food, delivery of goods, and taxi dispatch.

In addition, a waypoint of a mobile object may be obtained by any method. For example, a waypoint may be appropriately obtained with the use of demand prediction as in the above-described embodiments, or may be manually input.

In addition, a notification of a moving route may be repeatedly made until arrival at a final destination point. In addition, a route to the final destination may be obtained by one calculation. In addition, the calculation and notification of a moving route may be performed only for one or more of the mobile objects. In addition, a plurality of waypoints may be obtained. In addition, each mobile object can stay at a waypoint, and the stay time may be calculated. In addition, the mobile object may be notified of a moving route in which points are connected by a line or a road network.

In addition, in the fifth embodiment and the sixth embodiment described above, a case has been described as an example in which each of occurrence points, from each one of a plurality of past occurrence points, that exist in a range that allows the target ambulance to arrive at the destination within the designated time also by passing through the occurrence point is extracted, and each of the occurrence points is set as a processing target, but this is not restrictive. For example, in a case where there is no limitation on the time it takes to return to the fire station, the range, and the like, the clustering processing may be executed without extraction of each of occurrence points that exist in a range that allows for arrival at the destination within the designated time. In this case, among the past occurrence points, occurrence points at the same time of day in the same month of the previous year may be used.

In addition, in the fifth embodiment and the sixth embodiment described above, a case has been described as an example in which, in a case where an on-the-way ambulance is moving to a waypoint, the initial position is set to the waypoint for the on-the-way ambulance, but this is not restrictive, and the initial position may be set by any method. For example, in a case where an on-the-way ambulance is moving to a waypoint, the initial position may be set to the current position of the on-the-way ambulance. In this case, information regarding the waypoint for the on-the-way ambulance is unnecessary, and it is not necessary to acquire the information regarding the waypoint. In addition, in the fifth embodiment and the sixth embodiment described above, a case has been described as an example in which, in a case where an on-the-way ambulance is moving to a fire station, the position of the fire station is set as the initial position of the on-the-way ambulance, but this is not restrictive, and the initial position of the on-the-way ambulance may be set to the current position.

In addition, in the fifth embodiment and the sixth embodiment described above, a case has been described as an example in which the position of the fire station, the current position, or the waypoint may be set as the initial position of the clustering, but this is not restrictive, and the initial position may be set by any method.

In addition, in the fifth embodiment and the sixth embodiment described above, a case has been described as an example in which clustering is performed on each of occurrence points indicating positions from which the ambulance was called in the past, but this is not restrictive. For example, clustering may be performed on each of occurrence points included in a predictive distribution representing a demand prediction of occurrence points indicating positions from which the ambulance is called.

In each of the above embodiments, a case where a moving route for the target ambulance is set has been described as an example, but this is not restrictive, and only a waypoint may be set.

With regard to the above embodiments, the following supplementary notes are further disclosed.

(Supplementary Note 1)

A waypoint setting device including:
a memory; and
at least one processor connected to the memory,
in which the processor is configured to:
set a waypoint on the basis of a predictive distribution representing a demand prediction of occurrence points indicating positions from which a mobile object is called, position information indicating a position of a target mobile object that is a mobile object for which the waypoint is to be set, and destination information indicating information regarding a destination to which the target mobile object is to be moved; and
output the set waypoint.

(Supplementary Note 2)

A non-transitory storage medium that stores a program executable by a computer for execution of waypoint setting processing,
in which a waypoint is set on the basis of a predictive distribution representing a demand prediction of occurrence points indicating positions from which a mobile object is called, position information indicating a position of a target mobile object that is a mobile object for which the waypoint is to be set, and destination information indicating information regarding a destination to which the target mobile object is to be moved, and
the set waypoint is output.

### REFERENCE SIGNS LIST

1 Moving route setting system
10, 310, 510 Waypoint setting device
11 Network
12 Mobile terminal
100 Acquisition unit
101 Data storage unit
102 Demand prediction unit
104 Situation acquisition unit
106 Waypoint setting unit
108 Moving route setting unit
110 Output unit
300 State prediction unit
500 Clustering unit

1. A waypoint setting device comprising:
a waypoint setting circuitry that sets a waypoint based on a predictive distribution representing a demand prediction of occurrence points indicating positions from which a mobile object is called, position information indicating a position of a target mobile object that is a mobile object for which the waypoint is set, and destination information indicating information regarding a destination to which the target mobile object moves to; and
an output circuitry that outputs the waypoint set by the waypoint setting circuitry.

2. The waypoint setting device according to claim 1, further comprising:
a moving route setting circuitry that sets a moving route between the target mobile object and the destination in such a way that the moving route passes through the waypoint set by the waypoint setting circuitry,
wherein the output circuitry outputs the moving route set by the moving route setting circuitry.

3. The waypoint setting device according to claim 2, wherein
the waypoint setting circuitry resets the waypoint in a case where a preset condition is satisfied,
the moving route setting circuitry resets the moving route in such a way that the moving route passes through the waypoint reset by the waypoint setting circuitry, and
the output circuitry outputs the moving route reset by the moving route setting circuitry.

4. The waypoint setting device according to claim 1, further comprising:
a state prediction circuitry that predicts, based on history information regarding a history of each one of a plurality of mobile objects different from the target mobile object, a state of the mobile object different from the target mobile object,
wherein the waypoint setting circuitry sets the waypoint for the target mobile object based on the state of the mobile object different from the target mobile object predicted by the state prediction circuitry.

5. The waypoint setting device according to claim 1, further comprising:
a clustering circuitry configured to:
extract, from each one of a plurality of the mobile objects, the target mobile object, an on-the-way mobile object that is a mobile object on a way to the waypoint or already positioned at the waypoint, and a waiting mobile object that is a mobile object waiting at a base,
set each of the target mobile object, the on-the-way mobile object, and the waiting mobile object as a center of one of a plurality of clusters,
allocate each of the occurrence points in the predictive distribution to any one of the plurality of clusters,
update a position of the center of the cluster corresponding to the target mobile object based on a result of the allocation of each of the occurrence points to the cluster, and
repeat allocation of each of the occurrence points to the cluster and update of the position of the center of the cluster corresponding to the target mobile object,
wherein the waypoint setting circuitry sets, as the waypoint for the target mobile object, the position of the center of the cluster corresponding to the target mobile object obtained from a result of clustering by the clustering circuitry.

6. The waypoint setting device according to claim 5, wherein
the clustering circuitry is configured to:
calculate, when allocating each of the occurrence points to any one of the plurality of clusters for each one of the plurality of the mobile objects, a probability Pₙ (n=1, 2, . . . , N) that the mobile object moves and the center of the cluster corresponding to the mobile object disappears, and calculate a cluster assignment probability representing a probability that the occurrence point is assigned to the cluster of the mobile object based on the probability Pₙ that the center of the cluster disappears; and
update the position of the center of the cluster corresponding to the target mobile object based on each of the cluster assignment probabilities and each of positions of the occurrence points when updating the position of the center of the cluster corresponding to the target mobile object, and repeat allocation of each of the occurrence points to the cluster and update of the position of the center of the cluster corresponding to the target mobile object.

7. A waypoint setting method, the method comprising:
setting a waypoint based on a predictive distribution representing a demand prediction of occurrence points indicating positions from which a mobile object is called, position information indicating a position of a target mobile object that is a mobile object for which the waypoint is to be set, and destination information indicating information regarding a destination to which the target mobile object is to be moved; and
outputting the set waypoint.

8. A waypoint setting program for causing a computer to function as the waypoint setting device according to claim 1.

9. The waypoint setting device according to claim 1, wherein
a moving route setting circuitry that sets a moving route between the target mobile object and the destination in such a way that the moving route passes through the waypoint set by the waypoint setting circuitry,
wherein the output circuitry outputs the moving route set by the moving route setting circuitry,
the waypoint setting device, further comprising:
a state prediction circuitry that predicts, based on history information regarding a history of each one of a plurality of mobile objects different from the target mobile object, a state of the mobile object different from the target mobile object,
wherein the waypoint setting circuitry sets the waypoint for the target mobile object based on the state of the mobile object different from the target mobile object predicted by the state prediction circuitry.

10. The waypoint setting device according to claim 1, wherein
a moving route setting circuitry that sets a moving route between the target mobile object and the destination in such a way that the moving route passes through the waypoint set by the waypoint setting circuitry,
wherein the output circuitry outputs the moving route set by the moving route setting circuitry,
the waypoint setting circuitry resets the waypoint in a case where a preset condition is satisfied,
the moving route setting circuitry resets the moving route in such a way that the moving route passes through the waypoint reset by the waypoint setting circuitry, and
the output circuitry outputs the moving route reset by the moving route setting circuitry,
the waypoint setting device, further comprising:
a state prediction circuitry that predicts, based on history information regarding a history of each one of a plurality of mobile objects different from the target mobile object, a state of the mobile object different from the target mobile object,
wherein the waypoint setting circuitry sets the waypoint for the target mobile object based on the state of the mobile object different from the target mobile object predicted by the state prediction circuitry.

11. The waypoint setting device according to claim 1, further comprising:
a moving route setting circuitry that sets a moving route between the target mobile object and the destination in such a way that the moving route passes through the waypoint set by the waypoint setting circuitry,
wherein the output circuitry outputs the moving route set by the moving route setting circuitry, and
a waypoint setting program for causing a computer to function as the waypoint setting device according to claim 1.

12. The waypoint setting device according to claim 1, further comprising:
a moving route setting circuitry that sets a moving route between the target mobile object and the destination in such a way that the moving route passes through the waypoint set by the waypoint setting circuitry,
wherein the output circuitry outputs the moving route set by the moving route setting circuitry,
the waypoint setting circuitry resets the waypoint in a case where a preset condition is satisfied,
the moving route setting circuitry resets the moving route in such a way that the moving route passes through the waypoint reset by the waypoint setting circuitry,
the output circuitry outputs the moving route reset by the moving route setting circuitry, and
a waypoint setting program for causing a computer to function as the waypoint setting device according to claim 1.

13. The waypoint setting device according to claim 1, further comprising:
a moving route setting circuitry that sets a moving route between the target mobile object and the destination in such a way that the moving route passes through the waypoint set by the waypoint setting circuitry,
wherein the output circuitry outputs the moving route set by the moving route setting circuitry,
the waypoint setting circuitry resets the waypoint in a case where a preset condition is satisfied,
the moving route setting circuitry resets the moving route in such a way that the moving route passes through the waypoint reset by the waypoint setting circuitry,
the output circuitry outputs the moving route reset by the moving route setting circuitry,
a state prediction circuitry that predicts, based on history information regarding a history of each one of a plurality of mobile objects different from the target mobile object, a state of the mobile object different from the target mobile object,
wherein the waypoint setting circuitry sets the waypoint for the target mobile object based on the state of the mobile object different from the target mobile object predicted by the state prediction circuitry, and
a waypoint setting program for causing a computer to function as the waypoint setting device according to claim 1.

14. The waypoint setting device according to claim 1, further comprising:
a moving route setting circuitry that sets a moving route between the target mobile object and the destination in such a way that the moving route passes through the waypoint set by the waypoint setting circuitry,
wherein the output circuitry outputs the moving route set by the moving route setting circuitry,
the waypoint setting circuitry resets the waypoint in a case where a preset condition is satisfied,
the moving route setting circuitry resets the moving route in such a way that the moving route passes through the waypoint reset by the waypoint setting circuitry,
the output circuitry outputs the moving route reset by the moving route setting circuitry,
a state prediction circuitry that predicts, based on history information regarding a history of each one of a plurality of mobile objects different from the target mobile object, a state of the mobile object different from the target mobile object,
wherein the waypoint setting circuitry sets the waypoint for the target mobile object based on the state of the mobile object different from the target mobile object predicted by the state prediction circuitry, and
a clustering circuitry configured to:
extract, from each one of a plurality of the mobile objects, the target mobile object, an on-the-way mobile object that is a mobile object on a way to the waypoint or already positioned at the waypoint, and a waiting mobile object that is a mobile object waiting at a base,
set each of the target mobile object, the on-the-way mobile object, and the waiting mobile object as a center of one of a plurality of clusters,
allocate each of the occurrence points in the predictive distribution to any one of the plurality of clusters,
update a position of the center of the cluster corresponding to the target mobile object based on a result of the allocation of each of the occurrence points to the cluster, and
repeat allocation of each of the occurrence points to the cluster and update of the position of the center of the cluster corresponding to the target mobile object,
wherein the waypoint setting circuitry sets, as the waypoint for the target mobile object, the position of the center of the cluster corresponding to the target mobile object obtained from a result of clustering by the clustering circuitry, and
a waypoint setting program for causing a computer to function as the waypoint setting device according to claim 1.

15. The waypoint setting device according to claim 1, further comprising:
a moving route setting circuitry that sets a moving route between the target mobile object and the destination in such a way that the moving route passes through the waypoint set by the waypoint setting circuitry,
wherein the output circuitry outputs the moving route set by the moving route setting circuitry,
the waypoint setting circuitry resets the waypoint in a case where a preset condition is satisfied,
the moving route setting circuitry resets the moving route in such a way that the moving route passes through the waypoint reset by the waypoint setting circuitry,
the output circuitry outputs the moving route reset by the moving route setting circuitry,
a state prediction circuitry that predicts, based on history information regarding a history of each one of a plurality of mobile objects different from the target mobile object, a state of the mobile object different from the target mobile object,
wherein the waypoint setting circuitry sets the waypoint for the target mobile object based on the state of the mobile object different from the target mobile object predicted by the state prediction circuitry, and
a clustering circuitry configured to:
extract, from each one of a plurality of the mobile objects, the target mobile object, an on-the-way mobile object that is a mobile object on a way to the waypoint or already positioned at the waypoint, and a waiting mobile object that is a mobile object waiting at a base,
set each of the target mobile object, the on-the-way mobile object, and the waiting mobile object as a center of one of a plurality of clusters,
allocate each of the occurrence points in the predictive distribution to any one of the plurality of clusters,
update a position of the center of the cluster corresponding to the target mobile object based on a result of the allocation of each of the occurrence points to the cluster, and
repeat allocation of each of the occurrence points to the cluster and update of the position of the center of the cluster corresponding to the target mobile object,
wherein the waypoint setting circuitry sets, as the waypoint for the target mobile object, the position of the center of the cluster corresponding to the target mobile object obtained from a result of clustering by the clustering circuitry, and
the clustering circuitry is further configured to:
calculate, when allocating each of the occurrence points to any one of the plurality of clusters for each one of the plurality of the mobile objects, a probability Pₙ (n=1, 2, . . . , N) that the mobile object moves and the center of the cluster corresponding to the mobile object disappears, and calculate a cluster assignment probability representing a probability that the occurrence point is assigned to the cluster of the mobile object based on the probability Pₙ that the center of the cluster disappears;
update the position of the center of the cluster corresponding to the target mobile object based on each of the cluster assignment probabilities and each of positions of the occurrence points when updating the position of the center of the cluster corresponding to the target mobile object, and repeat allocation of each of the occurrence points to the cluster and update of the position of the center of the cluster corresponding to the target mobile object, and
a waypoint setting program for causing a computer to function as the waypoint setting device according to claim 1.
